(19) United States
(12) Patent Application Publication
(10) Pub. No.: US 2006/0097113 A1
(43) Pub. Date: May 11, 2006

(54) Payload ejection system

(75) Inventor: Gary Bryan Landsberg, Stewartstown, PA (US)

Correspondence Address: VENABLE LLP, P.O. BOX 34385, WASHINGTON, DC, 20045-9998, US

(73) Assignee: AAI Corporation, Hunt Valley, MD (US)

(21) Appl. No.: 10/965,727

(22) Filed: Oct. 18, 2004

(51) Int. Cl. B64D 1/12

(52) U.S. Cl. 244/137.4

(57) ABSTRACT

A payload ejection system is provided for ejecting a payload from a transport vehicle. The system has an ejector mechanism for applying an ejection force to the payload to urge the payload away from the transport vehicle, and a release mechanism for releasing the payload from a restrained state. The release mechanism has a payload mounting bolt for holding the payload in the restrained state, and an actuator that fractures the mounting bolt. The actuator has a shape memory alloy, and an activator that transforms the shape memory alloy from a compressed state to an elongated state. The actuator fractures the mounting bolt as the shape memory alloy transforms into the elongated shape.

### BACKGROUND OF THE INVENTION

The invention relates to release mechanisms, more particularly to payload release mechanisms.

Known aircraft payload release mechanisms for bombs, missiles and other expendable stores release the payload using pyrotechnic bolts, servos, pneumatic pistons, electric motors or solenoids. Servos, electric motors, pneumatic pistons and solenoids are relatively heavy and often rely on a complex mechanical system of levers to release and eject the payload. Pyrotechnic bolts require a secondary mechanism to push the payload away from the aircraft. Such secondary mechanisms often include pneumatic pistons that require a high pressure supply tank on the aircraft.

### SUMMARY OF THE INVENTION

A more simple and light weight payload ejection system is desirable from both reliability and cost standpoints.

An embodiment of the invention provides a payload ejection system for ejecting a payload from a transport vehicle. The system has an ejector mechanism for applying an ejection force to the payload to urge the payload away from the transport vehicle, and a release mechanism for releasing the payload from a restrained state. The release mechanism has a payload mounting bolt for holding the payload in the restrained state, and an actuator that fractures the mounting bolt. The actuator has a shape memory alloy, and an activator that transforms the shape memory alloy from a compressed state to an elongated state. The actuator fractures the mounting bolt as the shape memory alloy transforms into the elongated shape.

Other embodiments of the invention provide a method for ejecting a payload from a transport vehicle. The method includes restraining the payload to the transport vehicle with a payload mounting bolt; releasing the payload from the restrained state by fracturing the payload mounting bolt, the fracturing being accomplished by transforming a shape memory alloy from a compressed state to an elongated state; and applying an ejection force to the payload to urge the payload away from the transport vehicle.

Other embodiments of the invention provide a system for ejecting a payload from a transport vehicle. The system has a payload mounting bolt for restraining the payload to the transport vehicle; a device for releasing the payload from the restrained state by fracturing the payload mounting bolt, the fracturing being accomplished by transforming a shape memory alloy from a compressed state to an elongated state; and a device for applying an ejection force to the payload to urge the payload away from the transport vehicle.

### BRIEF DESCRIPTION OF THE DRAWINGS

Further advantages and details of the invention follow from the exemplary embodiments and are explained in the following with the aid of the Figures, in which:

FIG. 1 is a front view of an example of a payload ejection system in accordance with the invention;

FIG. 2 is a sectional side view along section line II-II of the system shown in FIG. 1;

FIG. 3 is an example of a payload mounting bolt in accordance with the invention;

FIG. 4 shows an example of a payload ejection system in accordance with the invention in a compressed state;

FIG. 5 shows the system of FIG. 4 in a compressed state with safety pins removed; and

FIG. 6 shows the system of FIG. 4 in an extended state.

### DETAILED DESCRIPTION OF THE INVENTION

The invention will be described using the example of a payload ejection system mounted to an aircraft. The invention provides a payload ejection system that overcomes many of the problems associated with payload ejection systems currently in use. The system has two main components, an ejector mechanism and a payload release mechanism.

The ejector mechanism provides self-contained stored energy for ejecting the payload away from the aircraft carrying the payload. The payload release mechanism releases the energy stored in the ejector mechanism upon receiving a launch signal.

In the example shown in the drawings, the ejector mechanism uses two springs to store the energy needed to eject the payload from the aircraft. By using compressed springs, no ejector mechanism energy source (such as, for example, compressed air cylinders) is needed on the aircraft.

The payload release mechanism uses an actuator that fractures a payload mounting bolt so as to release the energy stored in the ejector mechanism (in this example, the springs). One example of an appropriate actuator is an actuator that has a shape memory alloy and an activator that transforms the shape memory alloy from a compressed state to an elongated state. Such an actuator is used to fracture a payload mounting bolt at a weakened area of the bolt. The payload mounting bolt is designed to fracture under a force that is less than the force exerted by the shape memory alloy when it is transformed from the compressed state to the elongated state. This provides a reliable system for releasing the energy stored in the ejector mechanism.

One way to transform the shape memory alloy in the actuator is to apply an electric current to the shape memory alloy to raise its temperature above its transformation temperature, thus causing the shape memory alloy to expand and fracture the payload mounting bolt.

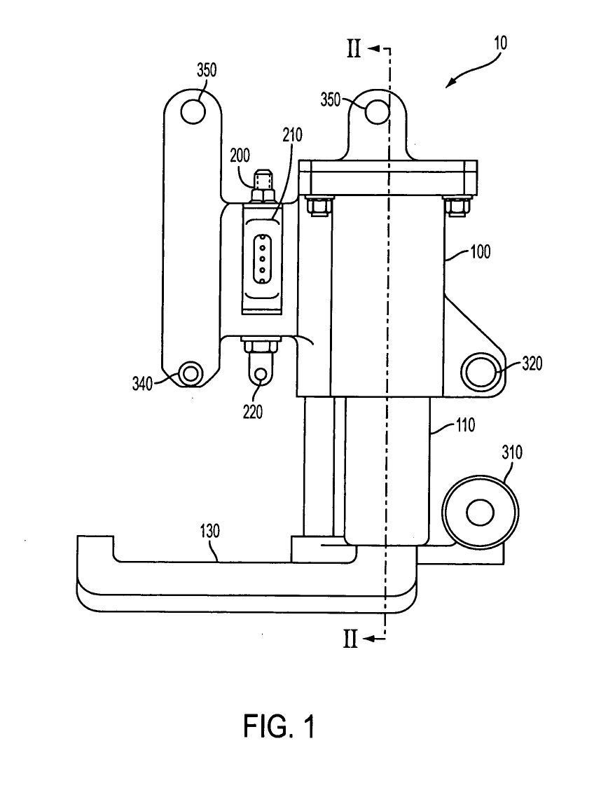

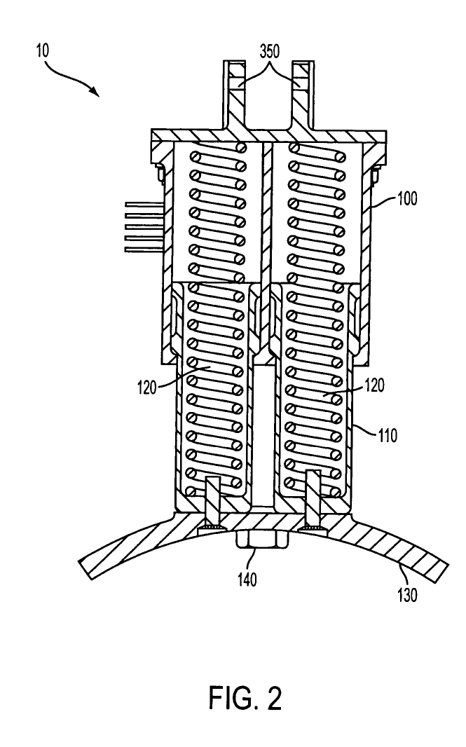

FIG. 1 shows a payload ejection system 10 for use with an aircraft. Payload ejection system 10 has an outer housing 100 and an inner housing 110 that slide relatively to each other such that a payload interface support plate 130 that is attached to inner house 110 moves up and down in the Figure relative to outer housing 100. FIG. 2 shows a cross section along section line II-II in FIG. 1. A pair of springs 120 that are housed inside outer housing 100 and inner housing 110 are shown in FIG. 2. Springs 120 provide the energy necessary for ejecting the payload from the aircraft. Although two springs 120 are shown in this example, it is noted that any appropriate number of springs can be used as long as they provide sufficient force to eject the payload from the aircraft. A spring compression bolt 140 is provided for compressing springs 120 prior to attaching the payload to payload ejection system 10.

An ejector spring retention pin hole 310 is provided on inner housing 110 and an ejector spring retention pinhole 320 is provided on outer housing 100. Holes 310, 320 are aligned when springs 120 are compressed and inner housing 110 moves upward in the Figure relative to outer housing 100 such that an ejection spring retention pin 330 can be inserted through holes 310, 320 to hold inner housing 110 in the compressed position.

A payload mounting bolt 200 is provided with a payload attachment point 220 for attaching the payload to payload mounting bolt 200. An actuator 210 is provided for fracturing payload mounting bolt 200 to release the payload.

This example also shows a pre-launch secondary payload safety pin mount 340 and two aircraft interface attachment points 350 in outer housing 100. Pre-launch secondary payload safety pin mount 340 is used to attach the payload to outer housing 100 prior to launch to help ensure that the payload is not ejected before the aircraft takes off. A secondary payload safety pin (not shown) is removed from pre-launch secondary payload pin mount 340 prior to the aircraft taking off.

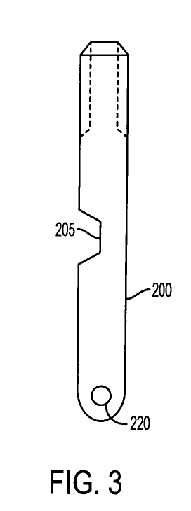

FIG. 3 shows an example of payload mounting bolt 200 having a notch 205. Notch 205 is provided as a weakened point in payload mounting bolt 200 at which payload mounting bolt 200 will fracture when actuator 210 is activated and, for example, the shape memory alloy expands from the compressed state to the expanded state. While FIG. 3 shows a notch in payload mounting bolt 200, it is noted that weakened areas of other shapes, materials or methods can also be used.

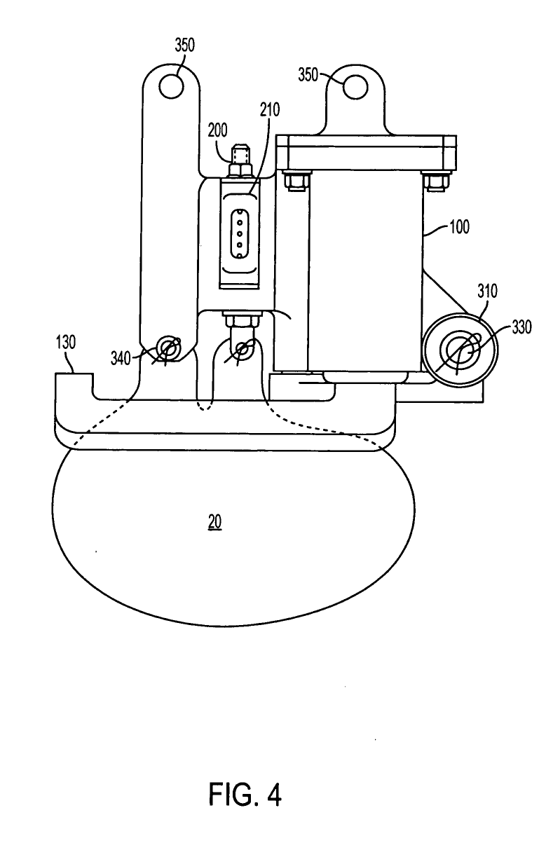

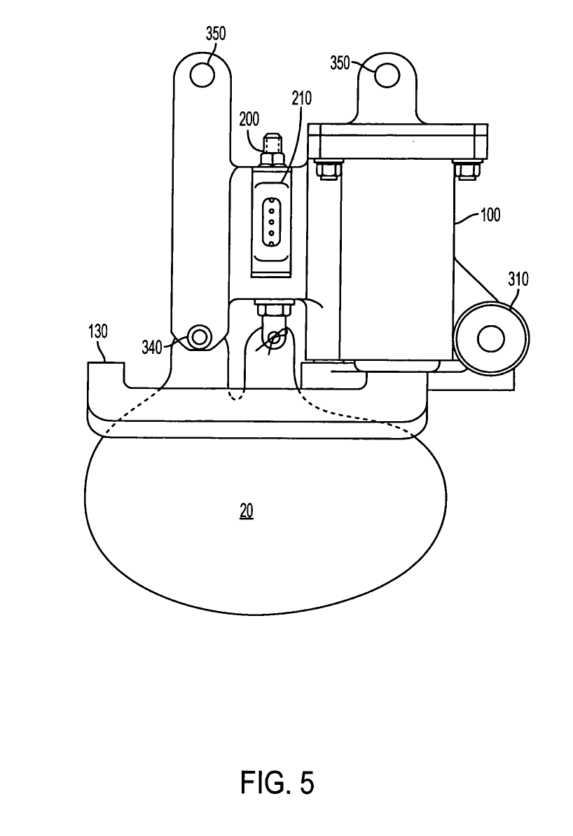

FIGS. 4-6 show an example of use of the invention. FIG. 4 shows payload ejection system 10 in the compressed state with ejector spring retention pin 330 and a secondary payload safety pin in place. This is an example of a configuration of the invention after the payload has been attached and immediately prior to the aircraft being ready for takeoff. FIG. 5 shows payload ejection system 10 in the compressed state with ejector spring retention pin 330 and the secondary payload safety pin removed. In this state, only payload attachment point 220 and, therefore, payload mounting bolt 200, is holding springs 120 in the compressed state. At this point, the aircraft is ready for takeoff.

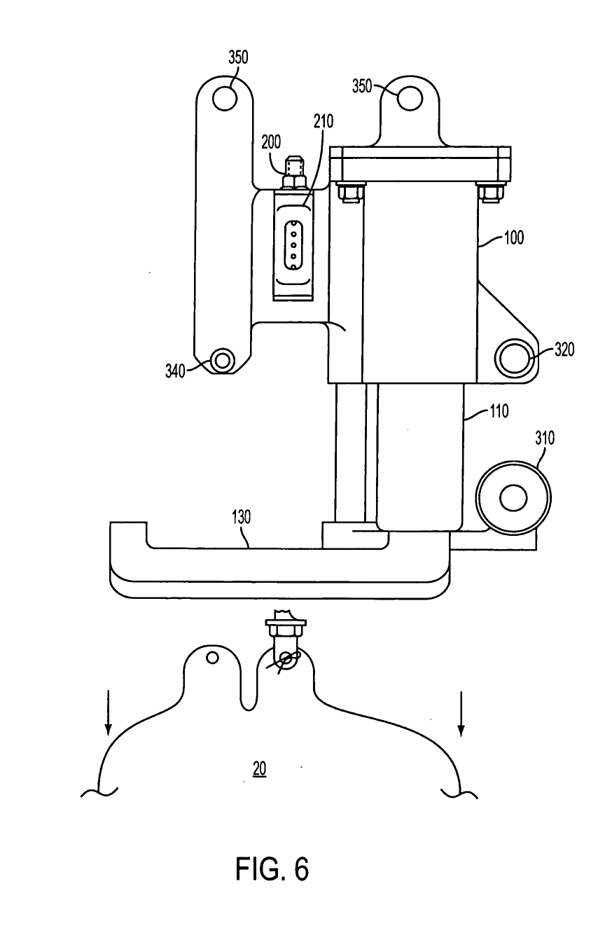

FIG. 6 shows the payload ejection system 10 after actuator 210 has been activated and payload mounting bolt 200 has fractured. At this point, springs 120 are released and provide the ejection force necessary to push payload 20 away from the aircraft.

Upon landing of the aircraft, payload ejection system 10 can be reused by compressing actuator 210 to its compressed state (this can be done, for example, in an external press) or replacing actuator 210 with another actuator 210 that has previously been compressed into the compressed state. Also, a new payload mounting bolt 200 is provided. Next, spring compression bolt 140 is installed and turned to compress springs 120 so that ejector spring retention pinholes 310, 320 align and ejector spring retention pin 330 can be installed. After ejector spring retention pin 330 is installed, spring compression bolt 140 is removed and the payload is installed and attached to payload attachment point 220. At this point, a pre-launch secondary payload safety pin can be used to secure the payload to pre-launch secondary payload safety pin mount 340. At this point, the launch sequence described above can be repeated.

As can be seen from the above-description, payload mounting bolt 200 and a pin that attaches the payload to payload attachment point 220 are the only parts of payload ejection systems 10 that are not reused.

The invention is not limited to the above-described exemplary embodiments. It will be apparent, based on this disclosure, to one of ordinary skill in the art that many changes and modifications can be made to the invention without departing from the spirit and scope thereof.

What is claimed is:

1. A payload ejection system for ejecting a payload from a transport vehicle, the system comprising:
an ejector mechanism for applying an ejection force to the payload to urge the payload away from the transport vehicle; and
a release mechanism for releasing the payload from a restrained state, the release mechanism having
a payload mounting bolt for holding the payload in the restrained state, and
an actuator that fractures the mounting bolt, the actuator comprising
a shape memory alloy, and
an activator that transforms the shape memory alloy from a compressed state to an elongated state,
wherein the actuator fractures the mounting bolt as the shape memory alloy transforms into the elongated shape.

2. The system of claim 1, wherein the activator transforms the shape memory alloy from the compressed state to the elongated shape by heating the shape memory alloy.

3. The system of claim 2, wherein the shape memory alloy is compressible from the elongated state to the compressed state and is reusable after it is compressed from the elongated state to the compressed state.

4. The system of claim 3, wherein the mounting bolt comprises a weakened area for fracturing when the activator transforms the shape memory alloy from the compressed state to the elongated state.

5. The system of claim 4, wherein the weakened area is a notch.

6. The system of claim 5, wherein the ejector mechanism comprises a spring for supplying the ejection force.

7. The system of claim 6, further comprising an ejection spring retention pin for holding the spring in a compressed state.

8. The system of claim 7, further comprising a spring compression bolt for compressing the spring into the compressed state.

9. The system of claim 1, wherein the shape memory alloy is compressible from the elongated state to the compressed state and is reusable after it is compressed from the elongated state to the compressed state.

10. The system of claim 1, wherein the mounting bolt comprises a weakened area for fracturing when the activator transforms the shape memory alloy from the compressed state to the elongated state.

11. The system of claim 10, wherein the weakened area is a notch.

12. A method for ejecting a payload from a transport vehicle, the method comprising:
restraining the payload to the transport vehicle with a payload mounting bolt;
releasing the payload from the restrained state by fracturing the payload mounting bolt, the fracturing being accomplished by transforming a shape memory alloy from a compressed state to an elongated state; and
applying an ejection force to the payload to urge the payload away from the transport vehicle.

13. The method of claim 12, wherein the shape memory alloy is transformed from the compressed state to the elongated shape by heating the shape memory alloy.

14. The method of claim 13, wherein the shape memory alloy is compressed from the elongated state to the compressed state and is reusable after it is compressed from the elongated state to the compressed state.

15. The method of claim 14, wherein the mounting bolt is fractured at a weakened area formed for fracturing when the shape memory alloy is transformed from the compressed state to the elongated state.

16. The method of claim 15, wherein the mounting bolt is fractured at a notch.

17. The method of claim 16, wherein the ejection force is supplied by a spring.

18. The method of claim 17, further comprising holding the spring in a compressed state with an ejection spring retention pin.

19. The method of claim 18, further comprising compressing the spring into the compressed state with a spring compression bolt.

20. A system for ejecting a payload from a transport vehicle, the system comprising:
a payload mounting bolt for restraining the payload to the transport vehicle;
means for releasing the payload from the restrained state by fracturing the payload mounting bolt, the fracturing being accomplished by transforming a shape memory alloy from a compressed state to an elongated state; and
means for applying an ejection force to the payload to urge the payload away from the transport vehicle.
